(19) United States
(12) Patent Application Publication
(10) Pub. No.: US 2026/0274287 A1
(43) Pub. Date: Sep. 17, 2026

(54) SYSTEMS AND METHODS FOR VEHICLE LOCALIZATION USING ADAPTIVE FILTERING AND A STANDARD MAP

(71) Applicant: Toyota Jidosha Kabushiki Kaisha, Toyota-shi Aichi-ken (JP)

(72) Inventor: Alexander Christoph Schaefer, Fremont, CA (US)

(73) Assignee: Toyota Jidosha Kabushiki Kaisha, Toyota-shi Aichi-ken (JP)

(21) Appl. No.: 19/078,752

(22) Filed: Mar. 13, 2025

(51) Int. Cl. B60W 60/00; B60W 50/00

(52) U.S. Cl. CPC B60W 60/001; B60W 50/00; B60W 2050/0052; B60W 2050/0083; B60W 2552/10; B60W 2556/40

(57) ABSTRACT

Systems, methods, and other embodiments described herein relate to adapting a filter for a particle set using sensor data and localizing vehicle position from the particle set using a standard map. In one embodiment, a method includes sampling a particle set representing vehicle position associated with a vehicle using a distribution model according to a road structure and a map about a road. The method also includes adapting a filter for the particle set from vehicle motion associated with the vehicle using sensor data, the particle set is associated with the road. The method also includes weighting the particle set using the sensor data. The method also includes controlling the vehicle on the road using a localized position derived from the particle set.

### TECHNICAL FIELD

The subject matter described herein relates, in general, to controlling a vehicle, and, more particularly, to adapting a filter using sensor data and deriving a localized position for the vehicle using a standard map.

### BACKGROUND

Vehicles equipped with sensors generate data that facilitates perceiving other vehicles, obstacles, and additional aspects of a surrounding environment. For example, a vehicle equipped with a light detection and ranging (LIDAR) sensor uses light to scan the surrounding environment. This allows logic associated with the LIDAR to analyze acquired data and detect object presence and other features of the surrounding environment. In further examples, additional sensors such as cameras are implemented to acquire information about the surrounding environment from which a system derives awareness about aspects of the surrounding environment. This sensor data and object presence can improve perceptions of the surrounding environment so that systems such as positioning and automated driving systems (ADS) can accurately plan and navigate a driving environment accordingly.

In various implementations, systems estimating a position of a vehicle for mission critical applications (e.g., automated driving) demand precise and detailed information. For example, a planning and control system that executes driving commands from the ADS encounters safety hazards using a digital map that lacks lane information. In one approach, systems utilize a high-definition (HD) map for estimating the position of the vehicle within a driving environment. In general, systems leveraging HD maps demand vast data and sensor systems that are complex. Acquiring the vast data and installing complex hardware can be unreasonable for certain vehicle platforms. Accordingly, these demands hinder localization availability and capabilities for vehicle control, thereby decreasing safety.

### SUMMARY

In one embodiment, example systems and methods relate to adapting a filter for a particle set using sensor data and localizing vehicle position from the particle set using a standard map. In various implementations, systems utilize a high-definition (HD) map for various tasks. For instance, an automated driving system (ADS) uses the HD map to make a turn at an intersection. An HD map can include detailed information about road topology, lane markings, roadside objects, and traffic signals. The HD map can also include 3D representations of the environment. The ADS can leverage this data to accurately and reliably determine position for navigating complex road scenarios. However, automated vehicles encounter elevated costs from HD maps due to vast data requirements and regular updates for maintaining information details. Furthermore, map-free systems that rely on real-time sensor data and machine learning to navigate dynamically without HD maps can be computationally costly. Thus, systems navigating a driving scenario with and without an HD map encounter technical difficulties and resource constraints, thereby hindering advanced tasks.

Therefore, in one embodiment, an adaptation system localizes a vehicle against a map through adapting a filter for a particle set using sensor data and localizing position from the particle set upon weighting. In particular, the standard map can be one of a standard-definition map and an enhanced standard-definition (ESD) map that improves geometric accuracy for systems estimating a topological location. For example, the ESD map is a simplified form of the HD map. This allows the adaptation system to estimate one of a vehicle-road association and a vehicle-lane association that improves position localization.

In one approach, estimating associations includes sampling a particle set that represents vehicle position using a distribution model for a road structure. The adaptation system can adapt a filter for the particle set from vehicle motion associated with the vehicle using sensor data acquired by a vehicle. Here, the particle set can represent multiple hypotheses for the vehicle position. Furthermore, the adaptation system can derive the localized position and associations using distributed values of the particle set that can be weighted using the sensor data. In this way, downstream planning and control exhibit superior performance from using one of a vehicle-road association and a vehicle-lane association as inputs for the localized position, thereby improving system performance.

In one embodiment, an adaptation system that adapts a filter for a particle set using sensor data and localizes vehicle position from the particle set using a standard map is disclosed. The adaptation system includes a memory storing instructions that, when executed by a processor, cause the processor to sample a particle set representing vehicle position associated with a vehicle using a distribution model according to a road structure and a map about a road. The instructions also include instructions to adapt a filter for the particle set from vehicle motion associated with the vehicle using sensor data, the particle set is associated with the road. The instructions also include instructions to weight the particle set using the sensor data. The instructions also include instructions to control the vehicle on the road using a localized position derived from the particle set.

In one embodiment, a non-transitory computer-readable medium for adapting a filter for a particle set using sensor data and localizing vehicle position from the particle set using a standard map and including instructions that when executed by a processor cause the processor to perform one or more functions is disclosed. The instructions include instructions to sample a particle set representing vehicle position associated with a vehicle using a distribution model according to a road structure and a map about a road. The instructions also include instructions to adapt a filter for the particle set from vehicle motion associated with the vehicle using sensor data, the particle set is associated with the road. The instructions also include instructions to weight the particle set using the sensor data. The instructions also include instructions to control the vehicle on the road using a localized position derived from the particle set.

In one embodiment, a method for adapting a filter for a particle set using sensor data and localizing vehicle position from the particle set using a standard map is disclosed. In one embodiment, the method includes sampling a particle set representing vehicle position associated with a vehicle using a distribution model according to a road structure and a map about a road. The method also includes adapting a filter for the particle set from vehicle motion associated with the vehicle using sensor data, the particle set is associated with the road. The method also includes weighting the particle set using the sensor data. The method also includes controlling the vehicle on the road using a localized position derived from the particle set.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an adaptation system that is associated with adapting a filter for a particle set using sensor data and localizing vehicle position from the particle set on a standard map.

FIGS. 3A and 3B illustrate examples of particle sets derived from the sensor data and road associations.

FIG. 4 illustrates an example of localizing position for a vehicle along a segmented road using a standard map.

FIG. 5 illustrates one embodiment of a method that is associated with adapting a filter for a particle set from vehicle motion using sensor data and controlling a vehicle using a localized position derived from the particle set.

### DETAILED DESCRIPTION

Systems, methods, and other embodiments associated with adapting a filter for a particle set using sensor data and localizing vehicle position from the particle set using a standard map are disclosed herein. In various implementations, systems utilize a high-definition (HD) map and sensor data for vehicle localization involving demanding applications. For instance, a vehicle automatically navigates an area with an HD map using fine details such as street lights, lane geometries, and lane types. However, these systems encounter several technical challenges associated with processing vast data from sensors including a light detection and ranging (LiDAR) sensor, a camera, and a positioning system when following the HD map that can be resource-intensive. Furthermore, localization can frequently demand real-time updates to HD maps for reflecting current environments that increase communication and computing costs. The high costs associated with creating and maintaining these maps stem from the need for advanced sensors and frequent updates. Weather (e.g., heavy rain, snow, etc.) can also obscure road features that further increase data loads and reduce localization accuracy. As such, systems using HD maps and sensor data for navigating a driving scenario have technical challenges from computing and communication limits, thereby hindering advanced tasks associated with complex applications.

Therefore, in one embodiment, an adaptation system estimates a localized position of a vehicle traveling on a road using a standard map by sampling particles using a distribution model according to a road structure and adapting a filter for the particle set from vehicle motion using sensor data. In one approach, the particle set is sampled using a distribution model relative to the road structure for deriving a position geometry. Here, the particle set can represent multiple hypotheses of vehicle position and include a heading and a road identification (ID) about the road. Furthermore, the adaptation system estimates the localized position by weighting and comparing values from the particle set with measured data (e.g., odometry data) and computing a distance for the particle set and the measured data from road associations (e.g., lane lines). This allows the adaptation system to accurately compute the localized position using a standard map (e.g., a standard-definition map, an enhanced standard definition (ESD) map, etc.) and avoid the complexities of HD map-based computations. The adaptation system also improves over certain heuristic-based implementations through leveraging map topology from the ESD map and generating the multiple hypotheses while maintaining accuracy.

In various implementations, the adaptation system computes the localized position of the vehicle segment-by-segment using an ESD map from a road network that includes approximate centerline locations, lane information, and a topology about a road. This can include relating values from the particle set with a road ID and segment. Here, the adaptation system uses the values that includes a vehicle pose and a heading derived from the sensor data for localization. In this way, the adaptation system outputs localized position about a vehicle that can include a lane ID, a road ID, and a longitudinal position for the road ID using an ESD map, thereby avoiding implementation complexity from position localization with a HD map.

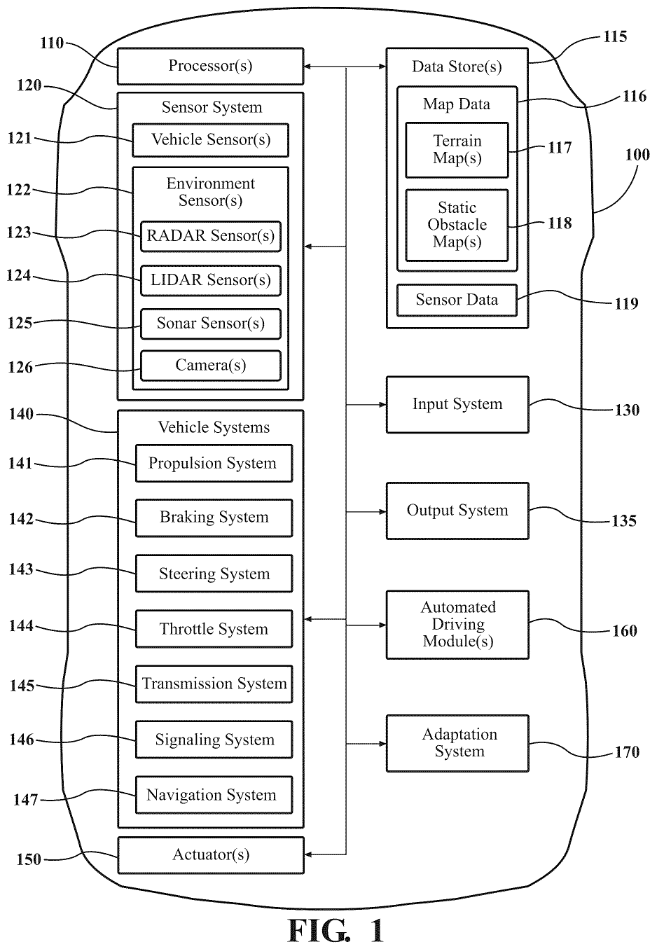

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an adaptation system 170 uses road-side units (RSU), consumer electronics (CE), mobile devices, robots, drones, and so on that benefit from the functionality discussed herein associated with adapting a filter for a particle set using sensor data and localizing vehicle position from the particle set using a standard map.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, one or more components of the disclosed system are implemented within the vehicle 100 while further components of the system are implemented within a cloud-computing environment or other system that is remote from the vehicle 100.

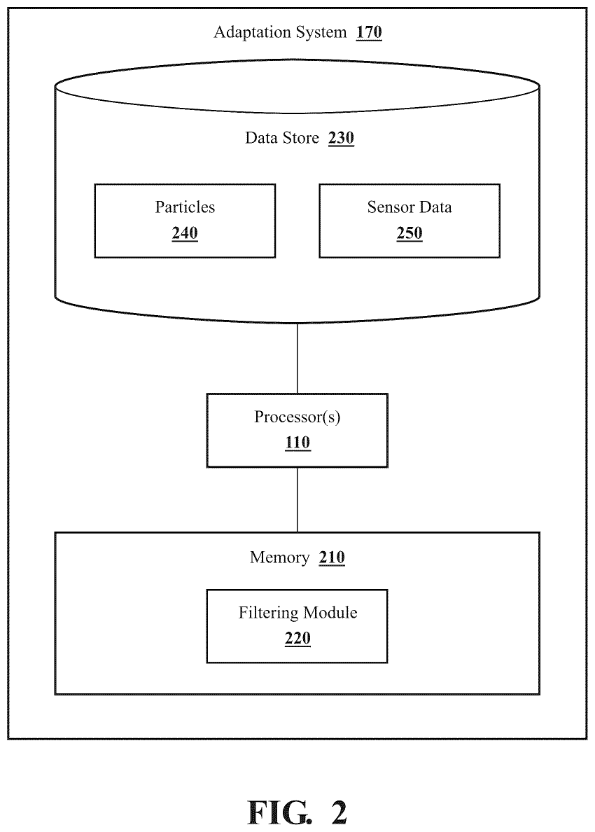

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an adaptation system 170 that is implemented to perform methods and other functions as disclosed herein relating to adapting a filter for a particle set using sensor data and localizing vehicle position from the particle set using a standard map.

With reference to FIG. 2, one embodiment of the adaptation system 170 of FIG. 1 is further illustrated. The adaptation system 170 is shown as including a processor(s) 110 from the vehicle 100 of FIG. 1. Accordingly, the processor(s) 110 may be a part of the adaptation system 170, the adaptation system 170 may include a separate processor from the processor(s) 110 of the vehicle 100, or the adaptation system 170 may access the processor(s) 110 through a data bus or another communication path. In one embodiment, the adaptation system 170 includes a memory 210 that stores a filtering module 220. The memory 210 is a random-access memory (RAM), a read-only memory (ROM), a hard-disk drive, a flash memory, or other suitable memory for storing the filtering module 220. The filtering module 220 is, for example, computer-readable instructions that when executed by the processor(s) 110 cause the processor(s) 110 to perform the various functions disclosed herein.

With reference to FIG. 2, the adaptation system 170 and/or the filtering module 220 generally include instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the adaptation system 170 and/or the filtering module 220, in one embodiment, acquires sensor data 250 that includes at least camera images. In further arrangements, the adaptation system 170 and/or the filtering module 220 acquires the sensor data 250 from further sensors such as radar sensors 123, LIDAR sensors 124, positioning information, and other sensors as may be suitable for identifying vehicles and locations of the vehicles.

Accordingly, the adaptation system 170 and/or the filtering module 220, in one embodiment, control the respective sensors to provide the data inputs in the form of the sensor data 250. Additionally, while the adaptation system 170 and/or the filtering module 220 are discussed as controlling the various sensors to provide the sensor data 250, in one or more embodiments, the adaptation system 170 and/or the filtering module 220 can employ other techniques to acquire the sensor data 250 that are either active or passive. For example, the adaptation system 170 and/or the filtering module 220 passively sniff the sensor data 250 from a stream of electronic information provided by the various sensors to further components within the vehicle 100. Moreover, the adaptation system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 includes, for example, information about lane markings, and so on. Moreover, the adaptation system 170 and/or the filtering module 220, in one embodiment, control the sensors to acquire the sensor data 250 about an area that encompasses 360 degrees about the vehicle 100 in order to provide a comprehensive assessment of the surrounding environment. Of course, in alternative embodiments, the adaptation system 170 and/or the filtering module 220 acquire the sensor data about a forward direction alone when, for instance, the vehicle 100 is not equipped with further sensors to include additional regions about the vehicle 100 and/or the additional regions are not scanned due to other reasons.

Moreover, in one embodiment, the adaptation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the filtering module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes particles 240 associated with a road that the vehicle 100 is traversing. For instance, the particles 240 form a set that represent multiple hypotheses of a vehicle position. This can include the particle set having a heading and a road ID for a segment associated with the road that the vehicle 100 is traversing.

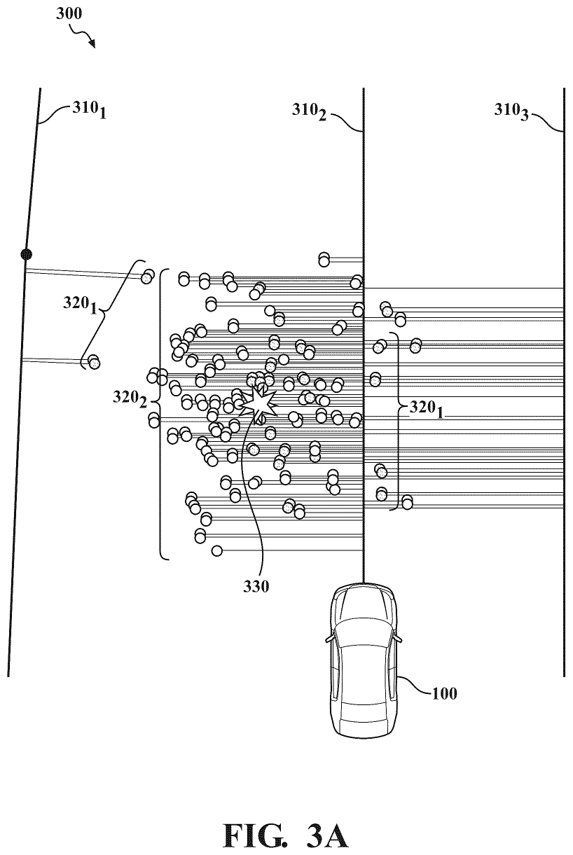

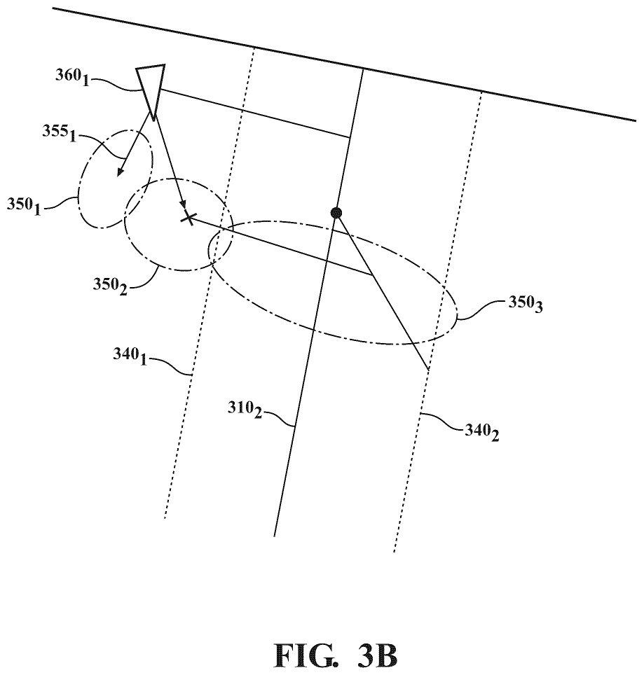

Now discussing FIGS. 3A and 3B, examples of particle sets derived from the sensor data 250 and road associations associated with the vehicle 100 are illustrated. The adaptation system 170 and/or the filtering module 220, in one embodiment, are further configured to perform additional tasks beyond controlling the respective sensors to acquire and provide the sensor data 250. For example, adaptation system 170 and/or the filtering module 220 include instructions that cause the processor 110 to sample a particle set representing vehicle position associated with the vehicle 100 using a distribution model (e.g., a gaussian model) according to a road structure and a map (e.g., a standard map, a standard-definition (SD) map, an ESD map, etc.) about a road 300. The map can be one of a standard map, an enhanced standard definition (ESD) map, etc., that includes centerline information about the road 300. For instance, an ESD map includes additional layers than a SD map having a number of lanes segment-by-segment on the road 300. The number of lanes can be associated with one of a segment and a portion about the road 300. The ESD map can also include lane types about the road 300 and a topology for the road 300.

The filtering module 220 can adapt a filter for the particle set from vehicle motion associated with the vehicle 100 using the sensor data 250 and a map. Here, the particle set is associated with the road 300 and the adaptation system 170 may weigh the particle set using the sensor data 250. For instance, the weighting involves compare values of the particle set with measured data (e.g., odometry data) and computing a distance for the particle set and the measured data. As such, the adaptation system 170 can control the vehicle 100 on the road 300 using a localized position derived from the particle set. The adaptation system 170 outputs localized position about the vehicle 100 including one of a lane ID, a road ID, a longitudinal position for the road ID using an ESD map, and a heading, thereby avoiding relying upon an HD map. This allows the adaptation system 170 to derive one of a road-level localization and a lane-level localization about the vehicle 100 traveling on the road 300. The road-level localization can include the road ID associated with the vehicle 100. The lane-level localization can include the lane ID about the vehicle 100 traversing the road 300.

Moreover, the adaptation system 170 sampling the particle set can involve relating a selected particle from the particle set with a road ID associated with a map. Here, the selected particle can include a pose that is centered using coordinates for a heading about the vehicle 100 from the sensor data 250. For instance, the pose includes a position and an orientation of the vehicle 100 among a road segment associated with the road 300. In one approach, this information is represented by coordinates and angles relative to a reference frame. As explained below, sampling and adaptive filtering can involve the adaptation system 170 projecting the coordinates to visualize a relationship between the vehicle 100 and one of a centerline and a lane of the road 300. This allows the adaptation system 170 to center the heading using an orientation of the road 300 factoring the coordinates, wherein the orientation is one of a travel direction, an inverse travel direction, a distance between the vehicle 100 and the road 300, and an angle between the vehicle 100 and the road 300 derived from the heading.

As explained in detail below, the adaptation system 170 adapting the filter for the particle set can include updating the vehicle motion and the distribution model using changing measured data from the sensor data 250. For instance, the adaptation system 170 advances a particle from the particle set using the vehicle motion and random noise applied from the distribution model. This facilitates the adaptation system 170 converging upon a segment and the localized position for the vehicle 100 on the road 300 using the particle set.

As explained below, localizing the vehicle 100 can include extruding centerlines laterally for roads associated with the road 300 by comparing lane counts that are perceived with a lane width having corresponding features on the map. This allows the adaptation system 170 to identify a drivable surface having the centerlines and the particle set through weighting a relationship between the particle set and the centerlines using the comparison. Here, an identification in part can occur during one of an initialization protocol and a motion update protocol. Furthermore, the adaptation system 170 can select randomly one of the roads for associating the particle set during one of the initialization protocol and the motion update protocol. The adaptation system 170 can subsequently localize position by updating a geometry (e.g., a pose) for a particle from the particle set and a heading about the vehicle 100 on the road 300. In one approach, the adaptation system 170 adjusts a road association between the vehicle 100 and the road 300 by checking that a projection of the particle is among a starting point and an endpoint of the road 300.

In FIG. 3A, the adaptation system 170 and/or the filtering module 220 may execute map-based particle filtering (MPF) by associating a particle with a road and intelligently updating a particle state with new odometry measurements. For example, odometry measurements for the vehicle 100 include a distance traveled, position change over time, velocity, tilt, wheel rotation, etc., using the sensor data 250. Lines 310₁ or 310₃ represent various centerlines of lanes associated with the road 300. Here, the adaptation system 170 may localize a position of the vehicle 100 using multiple sensor modalities. For instance, the vehicle 100 acquires the sensor data 250 that includes global navigation satellite system (GNSS) information, a global positioning system (GPS) information, odometry information, etc., with one of sensor system 120 and navigation system 147. The vehicle 100 also can determine lane count (e.g., left-right) from image features acquired using the camera(s) 126. In this way, the adaptation system 170 can execute MPF and localization for the vehicle 100 using a standard map (e.g., an ESD map).

The particles 320₁ and particles 320₂ from the particles 240 may form a set. Here, the set can represent multiple hypotheses of a position associated with the vehicle 100. The hypothesis may include a position (e.g., x, y, etc.) along with a heading and a road ID as iteratively assigned when the vehicle 100 traverses the road 300. This allows the adaptation system 170 to estimate road-level and lane-level localization for the vehicle 100 using sampling, adaptive filtering, and weighting of the particles 240. This can include weighting one of the particles 240 according to distance computation from position data and heading measurements.

In another embodiment, the centerlines 310₁-310₃ can be associated with the particles 320₁ that form a first particle set. The centerline 310₂ can be related and associated with the particles 320₂ that form a second particle set. In one approach, the adaptation system 170 hypothesizes that a point 330 is the likely longitudinal position for the next timestamp of the vehicle 100. In one approach, the adaptation system 170 infers the position from individually and separately grouping the particles 320₁ and the particles 320₂ and averaging the values.

As previously explained, the adaptation system 170 may sample a particle set representing a position of the vehicle 100 according to a structure and a map associated with the road 300. For instance, the adaptation system 170 samples particle poses from a gaussian distribution that is centered at the x-y-heading coordinates of a positioning measurement (e.g., GPS, GNSS, etc.) acquired from the navigation system 147. Furthermore, FIG. 3A illustrates that the adaptation system 170 associates a particle with a surrounding road (i.e., road ID) in a map (e.g., an ESD map). The vertical centerlines 310₁-310₃ may represent different roads. The horizontal lines to the particles 320₁ and the particles 320₂ can be distances to the associated roads. This allows identifying a viable range of vehicle positions through adaptive filtering and road associations.

Regarding details about particle filtering, a filtering iteration can include a motion update that is based on an odometry measurement and a standard map (e.g., an ESD map) and a measurement update using the positioning measurement (e.g., GPS, GNSS, etc.) acquired from the navigation system 147. For instance, odometry measurements include a distance traveled, position change over time, velocity, tilt, wheel rotation, etc., using the sensor data 250 along the centerlines 310₁-310₃. In one approach, the adaptation system 170 updates motion information about the vehicle 100 with a new odometry measurement. For example, a change in x by 1.0 meter and 0 in y causes a particle to advanced by 1.0 meter in the x-direction while adding random noise from the distributions. Furthermore, the adaptation system 170 executes additional tasks that maintain the particles 240 relative to the roadway and ensures accuracy. In this way, the adaptation system 170 rapidly converges onto a localized position for the vehicle 100 using the standard map.

The MPF may ensure that the particles 240 stay within the drivable surface of the road 300 as follows. The adaptation system 170 can assume that the particles 240 stay close to a drivable surface for the road 300. In one approach, modeling the assumption involves a probability distribution p(q|m). This represents the consistency of the vehicle 100 pose q with the associated road 300 and a map m (e.g., a standard map, an ESD map, etc.). As previously explained, the pose can include the position and orientation of the vehicle 100 among a road segment represented by coordinates and angles relative to a reference frame.

For tractability, the adaptation system 170 approximates the distribution as a trivariate distribution (e.g., a gaussian distribution) that forms x, y, and heading. For instance, x and y coordinates for the particles 240 associated with the distribution are centered at the projection of the particle position onto the centerline 310₂. The adaptation system 170 centers the heading at the orientation of the road 300 at the projection point for a respective particle. For example, the orientation is one of the travel direction and an inverse of the travel direction that is closer to the particle heading. The x-y covariances depend on the lane count of the road and a nominal lane width (e.g., 3 meters (m), 5 m, etc.). As such, a greater lateral component of the covariance is observed among a wider area of the road 300.

In various implementations, the adaptation system 170 integrates the assumption that particles stay close to the drivable surface among a road into a motion model that is map-based using the following approximation:

p(qₜ₊₁|qₜ, uₜ, m)~p(qₜ₊₁|qₜ, uₜ) p(qₜ₊₁|m), Equation (1)

where qₜ is the particle state at time t, uₜ is the odometry measurement at time t, and m denotes the map. In another approach, the adaptation system using Equation (1) multiplies the distributions for each particle that represents a noisy odometry increment and the consistency between vehicle pose and map. As a consequence, the particles will accurately follow and track the road 300 with a standard map through MPF.

FIG. 3B illustrates the following for maintaining accuracy and reliability during filtering between the particles 240 and relationships with the road 300. The adaptation system 170 models a drivable surface for the associated road 300 and boundary lines 340₁ and 340₂ using a distribution model. Here, the distribution model is shown as shapes 350₁-350₃ (e.g., confidence ellipses, confidence areas, etc.) upon applying random noise to the particles 240. The shapes 350₁-350₃ may represent odometry uncertainty and change with an iteration as the adaptation system 170 samples a new particle location. The arrow 355₁ is a motion update for position 360₁. For instance, a particle is pushed directionally towards the centerline 310₂ through a motion update using a distribution model. Moving the particle can involve multiplying values of shape 350₁ with a road surface probability represented by the shape 350₃ for localizing position with a standard map.

Regarding details about weighting, the adaptation system 170 upon a positioning measurement (e.g., GNSS, GPS, etc.) may compare a particle to the positioning measurement and weight the particle using a distance between the two. Particles closer to the positioning measurement are assigned a greater weight by the adaptation. In one approach, the adaptation system 170 groups the particles by associated roads and selects the groups with the greatest cumulated weights. This can include selecting a top X % of the particles 240 as grouped and averaging related values to localize the vehicle 100. As such, the adaptation system 170 converges on a single road and location through iterative updates of the hypotheses. This approach allows the adaptation system 170 to track multiple hypotheses at once, thereby providing robust localization using an ESD map.

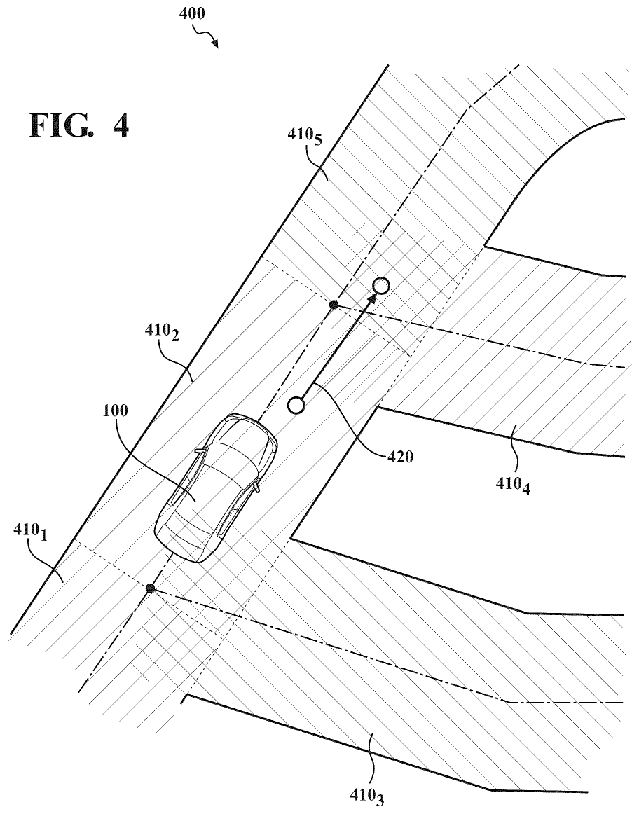

Now discussing FIG. 4, the vehicle 100 traveling along a centerline and a connected road 400 segmented by drivable surfaces 410₁ to 410₅. For example, the adaptation system 170 estimates the drivable surfaces 410₁-410₅ for road segments according to a number of lanes. After a motion update 420, the adaptation system 170 can reassociate a longitudinal position randomly and associate a particle.

In one approach, the vehicle 100 may be associated with either the drivable surface 410₄ or 410₅ upon the motion update 420. Here, the adaptation system 170 identifies an actual road association upon updating a geometric portion of the particles 240 through projections. For example, the adaptation system 170 verifies that a projection of one of the particles 240 falls in between a start pointing and an ending point of the drivable surfaces 410₁-410₅. If not, the adaptation system 170 estimates the drivable surfaces 410₁-410₅ of the connected road 400 by extruding centerlines laterally for efficiency. The extrusion distance depends on lane counts about the connected roads 400 that are perceived and comparing the lane counts with a lane width (e.g., 3 m, 5 m, 10 m, etc.) having corresponding features on the map. The adaptation system 170 can further verify that the drivable surface 410₄ or 410₅ for the motion update 420 contain a particle, such as during one of an initialization protocol and a motion update protocol. For example, the adaptation system 170 randomly selecting one of the intersecting roads and associating one of the particles 240 with a drivable surface during one of the initialization protocol and the motion update protocol.

In another embodiment, the adaptation system 170 subsequently localizes position by updating a geometry (e.g., a pose) for a particle from the particle set and a heading about the vehicle 100 on the road 300. As previously described, the adaptation system 170 can adjust a road association between the vehicle 100 and the road 300 by checking that a projection of the particle is among a starting point and an endpoint of the road 300.

An output of the adaptation system 170 can include a longitudinal position of the vehicle 100 derived from filtering and motion updates. For instance, motion updates propagate the particle set along a road graph as a particle filter tracks pose associated with the connected road 400. In another approach, the output includes a lane ID, a road ID, and a longitudinal position for the road ID using an ESD map that is associated with the connected road 400. In this way, the vehicle systems 140, automated driving module(s) 160, etc., can direct and guide tasks for the vehicle 100 accurately using the outputs and a map (e.g., a standard map, an ESD map, etc.) while avoiding the aforementioned complexities and availability of HD maps.

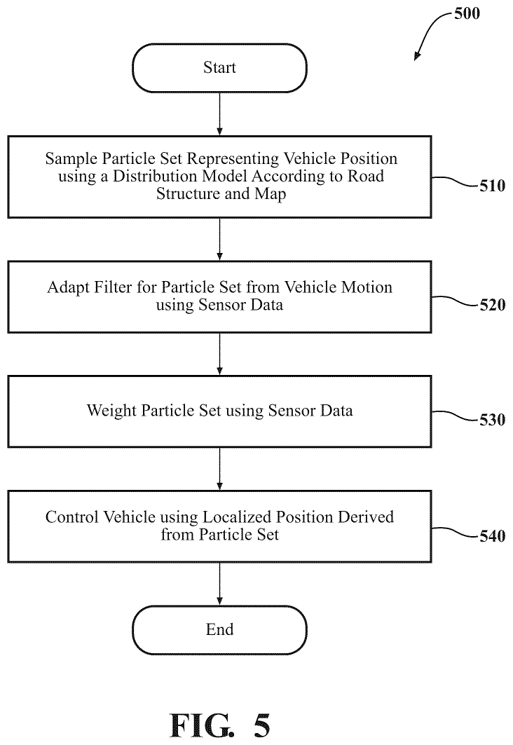

Now discussing FIG. 5, one embodiment of a method 500 that is associated with adapting a filter for the particles 240 from vehicle motion using the sensor data 250 and controlling the vehicle 100 using localized position is illustrated. The method 500 will be discussed from the perspective of the adaptation system 170 of FIGS. 1 and 2. While the method 500 is discussed in combination with the adaptation system 170, it should be appreciated that the method 500 is not limited to being implemented within the adaptation system 170 but is instead one example of a system that may implement the method 500. In one approach, the method 500 includes a map-based particle-filter that localizes position for the vehicle 100 using geometries about a road from an ESD map. The adaptation system 170 can accurately estimate a drivable surface using centerline information, map topology, and lane counts. As previously explained, motion updates propagate the particles 240 along a road graph and a particle filter tracks pose associated with the road having improved accuracy.

At 510, the adaptation system 170 initializes a protocol through sampling a particle set from the particles 240 representing a vehicle position using a distribution model according to a road structure and a map. The vehicle 100 may be traveling on a road having average lane and environmental details described by the map. Here, the particles set can represent multiple position hypotheses associated with the vehicle 100. This can include the particle set having a heading and a road ID for a segment associated with a road and the positioning during vehicle travel.

In one approach, the distribution model is a gaussian model and the map is an ESD map. As previously explained, sampling the particle set can involve relating a selected particle from the particle set with a road ID and the road structure associated with the map. For instance, the selected particle includes a pose of the vehicle 100 that is centered using heading-related coordinates derived from the sensor data 250. The pose can include the position and orientation of the vehicle 100 among a road segment represented by coordinates and angles relative to a reference frame (e.g., a centerline).

In another approach, the adaptation system 170 projects the coordinates onto a centerline of the road 300. This allows the adaptation system 170 to center the heading using an orientation of the road while factoring the coordinates. Furthermore, in one embodiment, the adaptation system 170 samples particle poses from a gaussian distribution that is centered at the x-y-heading coordinates of a positioning measurement (e.g., GPS, GNSS, etc.) acquired from the navigation system 147. For instance, the adaptation system 170 associates a particle with a surrounding road on an ESD map and centerlines for the road.

At 520, the adaptation system 170 and/or the filtering module 220 adapts a filter for the particle set from a vehicle motion using the sensor data 250. Here, the adaptation system 170 may acquire and update measurements for the sensor data 250 from the navigation system 147, the sensor system 120, and the camera(s) 126, etc. Adapting the filter can also include updating the vehicle motion and the distribution model using updated measured data from the sensor data 250. For instance, the adaptation system 170 advances a particle from the particle set using the vehicle motion and random noise applied from the distribution model. This allows the adaptation system 170 to rapidly converge onto a segment and the localized position for the vehicle 100 on the road 300 using the particle set.

In yet another approach, as previously explained, the adaptation system 170 groups particles by associated roads and selects the group through comparing cumulated weights. This can include selecting a top X % of the particles 240 as grouped and averaging related values to localize the vehicle 100. As such, the adaptation system 170 converges on a single road and location through iterative updates of the hypotheses.

At 530, the adaptation system weights the particle set using the sensor data 250. Here, the adaptation system 170 may acquire an updated positioning measurement (e.g., GNSS, GPS, etc.) and compare one of the particles 240 to the positioning measurement. Upon the comparison, the adaptation system 170 weights the particle using a distance between the particle coordinates and the positioning measurement. Furthermore, the adaptation system 170 executes motion updates through selecting data from various sources such as positioning information and odometry measurements. Here, a motion update may push a particle directionally towards a centerline among a segment, portion, etc., of the road associated with a localization protocol. As previously explained, this can include multiplying values of various shapes with a road surface probability associated with one or more of the particles 240.

At 540, the adaptation system 170 and the vehicle systems 140 control the vehicle 100 using localized position derived from the particle set. Here, the adaptation system 170 may output a longitudinal position relative to a centerline for the road. The longitudinal position can be derived from motion updates. For instance, motion updates propagate the particle set along a road graph and a particle filter tracks pose associated with the road. In another approach, the output includes including a lane ID, a road ID, and a longitudinal position for the road ID using an ESD. Accordingly, the adaptation system 170 outputs localized position about the vehicle 100 with increased accuracy using a map (e.g., a standard map, an ESD map, etc.) and particles, thereby reducing implementation costs and complexity from vehicle positioning with an HD map.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, the GNSS, the GPS, the navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the adaptation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the adaptation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the adaptation system 170, and/or the automated driving module(s) 160 can be operatively connected to communicate with the various vehicle systems 140 and/or individual components thereof. For example, the processor(s) 110, the adaptation system 170, and/or the automated driving module(s) 160 can be in communication to send and/or receive information from the various vehicle systems 140 to control the movement of the vehicle 100. The processor(s) 110, the adaptation system 170, and/or the automated driving module(s) 160 may control some or all of the vehicle systems 140.

The processor(s) 110, the adaptation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the adaptation system 170, and/or the automated driving module(s) 160 can control the direction and/or speed of the vehicle 100. The processor(s) 110, the adaptation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the adaptation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An adaptation system comprising:
a memory storing instructions that, when executed by a processor, cause the processor to:
sample a particle set representing vehicle position associated with a vehicle using a distribution model according to a road structure and a map about a road;
adapt a filter for the particle set from vehicle motion associated with the vehicle using sensor data, the particle set is associated with the road;
weight the particle set using the sensor data; and
control the vehicle on the road using a localized position derived from the particle set.

2. The adaptation system of claim 1, wherein the instructions to sample the particle set further include instructions to:
relate a selected particle from the particle set with a road identification associated with the map, wherein the selected particle includes a pose that is centered using coordinates about the vehicle from the sensor data;
project the coordinates to visualize a relationship between the vehicle and one of a centerline and a lane of the road; and
center a heading for the vehicle using an orientation of the road factoring the coordinates, wherein the orientation is one of travel direction, an inverse travel direction, a distance between the vehicle and the road, and an angle between the vehicle and the road derived from the heading.

3. The adaptation system of claim 1, wherein the instructions to adapt the filter for the particle set further include instructions to:
update the vehicle motion and the distribution model using measured data from the sensor data that changed;
advance a particle from the particle set using the vehicle motion and random noise applied from the distribution model; and
converge onto a segment and the localized position for the vehicle on the road using the particle.

4. The adaptation system of claim 3, wherein the instructions to weight the particle set using the sensor data further include instructions to:
compare values of the particle set with the measured data, wherein the measured data is odometry data; and
compute a distance for the particle set and the measured data.

5. The adaptation system of claim 3 further including instructions to:
extrude centerlines laterally for roads associated with the road by comparing lane counts that are perceived with a lane width having corresponding features on the map;
weight a relationship between the particle set and the centerlines;
identify a drivable surface having the centerlines and the particle set during one of an initialization protocol and a motion update protocol; and
select randomly one of the roads for associating the particle set during one of the initialization protocol and the motion update protocol.

6. The adaptation system of claim 1 further including instructions to:
update a geometry for a particle from the particle set, the geometry includes a pose; and
adjust a road association between the vehicle and the road by checking that a projection of the particle is among a starting point and an ending point of the road.

7. The adaptation system of claim 1, wherein:
the particle set represents multiple hypotheses of the vehicle position; and
the particle set includes a heading and a road identification for a segment associated with the road.

8. The adaptation system of claim 1, wherein:
the distribution model is a gaussian model;
the map is an enhanced standard definition (ESD) map that includes centerline information about the road, a number of lanes for the road, and a topology for the road;
the number of lanes are associated with one of a segment and a portion about the road;
the localized position includes one of a lane identification (ID), a road (ID), a longitudinal position for the road ID, and a heading about the vehicle; and
the localized position includes one a road-level localization having the road ID and a lane-level localization having the lane ID about the vehicle on the road.

9. A non-transitory computer-readable medium comprising:
instructions that when executed by a processor cause the processor to:
sample a particle set representing vehicle position associated with a vehicle using a distribution model according to a road structure and a map about a road;
adapt a filter for the particle set from vehicle motion associated with the vehicle using sensor data, the particle set is associated with the road;
weight the particle set using the sensor data; and
control the vehicle on the road using a localized position derived from the particle set.

10. The non-transitory computer-readable medium of claim 9, wherein the instructions to sample the particle set further include instructions to:
relate a selected particle from the particle set with a road identification associated with the map, wherein the selected particle includes a pose that is centered using coordinates for a heading about the vehicle from the sensor data;
project the coordinates to visualize a relationship between the vehicle and one of a centerline and a lane of the road; and
center a heading for the vehicle using an orientation of the road factoring the coordinates, wherein the orientation is one of travel direction, an inverse travel direction, a distance between the vehicle and the road, and an angle between the vehicle and the road derived from the heading.

11. The non-transitory computer-readable medium of claim 9, wherein the instructions to adapt the filter for the particle set further include instructions to:
update the vehicle motion and the distribution model using measured data from the sensor data that changed;
advance a particle from the particle set using the vehicle motion and random noise applied from the distribution model; and
converge onto a segment and the localized position for the vehicle on the road using the particle.

12. The non-transitory computer-readable medium of claim 11, wherein the instructions to weight the particle set using the sensor data further include instructions to:
compare values of the particle set with the measured data, wherein the measured data is odometry data; and
compute a distance for the particle set and the measured data.

13. A method comprising:
sampling a particle set representing vehicle position associated with a vehicle using a distribution model according to a road structure and a map about a road;
adapting a filter for the particle set from vehicle motion associated with the vehicle using sensor data, the particle set is associated with the road;
weighting the particle set using the sensor data; and
controlling the vehicle on the road using a localized position derived from the particle set.

14. The method of claim 13, wherein sampling the particle set further includes:
relating a selected particle from the particle set with a road identification associated with the map, wherein the selected particle includes a pose that is centered using coordinates for a heading about the vehicle from the sensor data;
projecting the coordinates to visualize a relationship between the vehicle and one of a centerline and a lane of the road; and
centering a heading for the vehicle using an orientation of the road factoring the coordinates, wherein the orientation is one of travel direction, an inverse travel direction, a distance between the vehicle and the road, and an angle between the vehicle and the road derived from the heading.

15. The method of claim 13, wherein adapting the filter for the particle set further includes:
updating the vehicle motion and the distribution model using measured data from the sensor data that changed;
advancing a particle from the particle set using the vehicle motion and random noise applied from the distribution model; and
converging onto a segment and the localized position for the vehicle on the road using the particle.

16. The method of claim 15, wherein weighting the particle set using the sensor data further includes:
comparing values of the particle set with the measured data, wherein the measured data is odometry data; and
computing a distance for the particle set and the measured data.

17. The method of claim 15 further comprising:
extruding centerlines laterally for roads associated with the road by comparing lane counts that are perceived with a lane width having corresponding features on the map;
weighting a relationship between the particle set and the centerlines;
identify a drivable surface having the centerlines and the particle set during one of an initialization protocol and a motion update protocol; and
select randomly one of the roads for associating the particle set during one of the initialization protocol and the motion update protocol.

18. The method of claim 13 further comprising:
updating a geometry for a particle from the particle set, the geometry includes a pose; and
adjusting a road association between the vehicle and the road by checking that a projection of the particle is among a starting point and an ending point of the road.

19. The method of claim 13, wherein:
the particle set represents multiple hypotheses of the vehicle position; and
the particle set includes a heading and a road identification for a segment associated with the road.

20. The method of claim 13, wherein:
the distribution model is a gaussian model;
the map is an enhanced standard definition (ESD) map that includes centerline information about the road, a number of lanes for the road, and a topology for the road;
the number of lanes are associated with one of a segment and a portion about the road;
the localized position includes one of a lane identification (ID), a road (ID), a longitudinal position for the road ID, and a heading about the vehicle; and
the localized position includes one a road-level localization having the road ID and a lane-level localization having the lane ID about the vehicle on the road.
